(19) United States
(12) Patent Application Publication
(10) Pub. No.: US 2003/0093904 A1
(43) Pub. Date: May 22, 2003

(54) Apparatus for machining, especially cutting tubular or round section bodies

(76) Inventor: Seppo Makkonen, Helsinki (FI)

Correspondence Address: Finn T Simmensen, Kleinberg & Lerner, Suite 1080, 2049 Century Park East, Los Angeles, CA, 90067, US

(21) Appl. No.: 10/312,351

(22) PCT Filed: May 16, 2001
(86) PCT No.: PCT/FI01/00476

(30) Foreign Application Priority Data
Jun. 30, 2000 (FI) 20001556

(51) Int. Cl. B26D 3/16

(52) U.S. Cl. 30/96; 30/94; 30/102

(57) ABSTRACT

The invention relates to an apparatus for machining, especially cutting tubular or round section bodies (1), said apparatus comprising a gripping mechanism (2), which is adapted to be braced on said machinable body (1) rotatably around the same and which gripping mechanism (2) is provided with a machining unit (3) fitted with adjusting means (4) for moving said machining unit (3) relative to the gripping mechanism (2) towards or away from the machinable body (1), and which gripping mechanism (2) includes a frame section (5) and first and second arms (6, 7) extending therefrom, the gripping mechanism (2) being adapted to brace against the machinable body (1) by means of bracing elements (14, 15, 16) mounted on the frame section (5) and the arms (6, 7). The arms (6, 7) are at one end articulated to the frame section (5) of the gripping mechanism (2) and the bracing elements (15, 16) included in the arms (6, 7) are mounted on the free ends of the arms. The frame section (5) of the gripping mechanism (2) is rotatably and axially immovably fitted with a threaded shaft (20), having at its first end a right hand thread with a first nut (21) and at its second end a left hand thread with a second nut (22), and said threaded shaft (20) being provided with an element (23) for rotating the threaded shaft (20). The first arm (6) and the first nut (21) are articulated to each other by means of a first bracket (24) and the second arm (7) and the second nut (22) are articulated to each other by means of a second bracket (25).

The invention relates to an apparatus for machining, especially cutting tubular or round section bodies, said apparatus comprising a gripping mechanism, which is adapted to be braced on said machinable body rotatably around the same and which gripping mechanism is provided with a machining unit fitted with adjusting means for moving said machining unit relative to the gripping mechanism towards or away from the machinable body, and which gripping mechanism includes a frame section and first and second arms extending therefrom, the gripping mechanism being adapted to brace against the machinable body by means of bracing elements mounted on the frame section and the arms.

There is a prior known pipe cutter, comprising a C-shaped frame provided with two rotatably bearing-mounted support wheels and a disc blade adjustable relative to the same. As the cutter is rotated upon said support wheels and disc blade around a pipe, while moving the disc blade towards the support wheels, the pipe will be cut. The process is slow and tedious, resulting in a deformation of the pipe and a cut surface with a burr, which must be cleaned in a separate process. The pipe cutter is only good for cutting. The pipe cutter of a given size is only good for pipes of a given diametral range. Consequently, varying pipe sizes require the use of various size pipe cutters. Varying pipe materials also require a frequent replacement of the cutting blade.

The publication DE 27 56 529 discloses an apparatus as set forth above. However, its use always requires a multitude of adjustment procedures every time there is a change in the size of a pipe to be cut.

It is an object of the invention to provide an apparatus for machining or handling tubular or round section bodies, said apparatus being especially good for cutting, but which apparatus, depending on its extra features, can also be used for other types of machining or handling, e.g. for making weld chamfers or for joining pipes by butt welding, and said apparatus being quickly and reliably adaptable for use with various size bodies at any point along the length of the body.

According to the invention, this object is accomplished in such a way that and an apparatus of the invention is characterized in that the arms are at one end articulated to the frame section of the gripping mechanism and the bracing elements included in the arms are mounted on the free ends of the arms, that the frame section of the gripping mechanism is rotatably and axially immovably fitted with a threaded shaft, having at its first end a right hand thread with a first nut and at its second end a left hand thread with a second nut, and said threaded shaft being provided with an element for rotating the threaded shaft, and that the first arm and the first nut are articulated to each other by means of a first bracket and the second arm and the second nut are articulated to each other by means of a second bracket.

In an apparatus of the invention, the gripping mechanism constitutes an independent assembly, to which a machining unit or the like is linked in a manner adjustable with respect to the gripping mechanism.

In a particularly preferred embodiment for an apparatus of the invention, wherein the apparatus is principally applied in the cutting of pipes or the like, the arrangement is such that the machining unit is constituted by a circular saw, which is braced to the gripping mechanism pivotably about an axis parallel to its axis of rotation and to the centre axis of a tubular or round section body presently in a machining or handling position. In this case, the apparatus is preferably designed as a hand tool. Hence, the cutting of a pipe is performed in such a way that the gripping mechanism is braced to a pipe to be cut, followed by pressing the circular saw against the pipe until the blade in its lower position has penetrated the pipe wall. This is followed by rotating the gripping mechanism and the saw around the pipe, while maintaining the relative position thereof, whereby the pipe is cut. Alternatively, the gripping mechanism and the saw are maintained stationary and the pipe is rotated.

Thus, the apparatus offers a multitude of benefits, including e.g. the following features:

The use of a circular saw blade, especially a circular blade fitted with hard metal tips, readily enables the cutting of a number of pipe materials over a wide range of diameters.

The cutting occurs quickly, with no burr formation and no pipe deformation.

The machining produces hardly any sparking, thus no hot work permit is required unlike in the use of e.g. a conventional angle grinder.

The cutting proceeds always in a straight line, producing excellent cutting trace.

The circular blade sawing angle does not change during the cutting, the blades thus enjoying a service life and sharpening intervals substantially longer than those of a conventional cutting saw, the latter performing the cutting by means of a top feeding, large-diameter circular blade.

The ability to use small-diameter, hence attractively priced circular blades.

The apparatus can be maintained low weight, making it a highly useful hand tool.

The invention will be described now in more detail with reference to the accompanying drawing, in which:

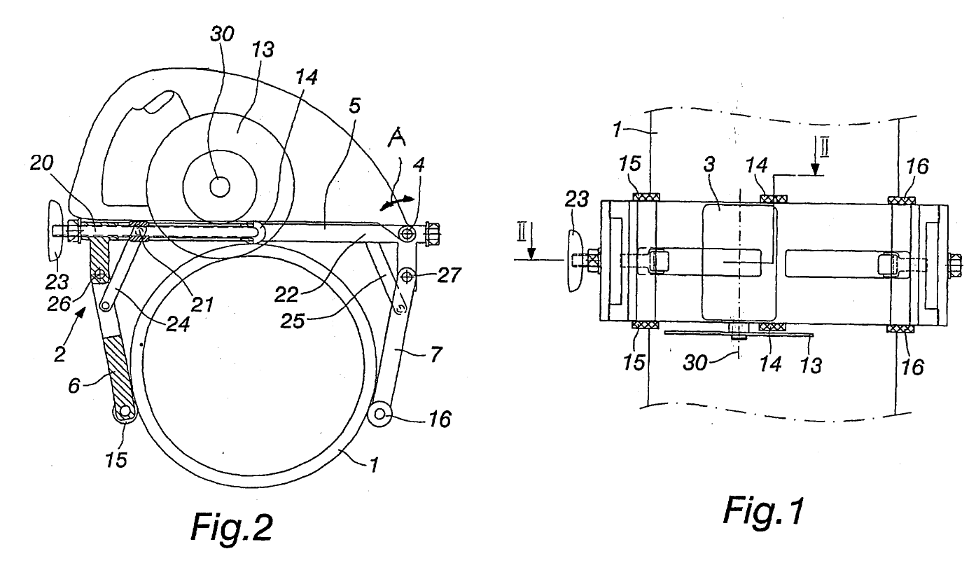

FIG. 1 shows one preferred embodiment of the invention in a schematic plan view.

FIG. 2 shows a section along a line II-II in FIG. 1.

Regarding an apparatus of the invention for machining or handling tubular or round section bodies 1, the drawing depicts an application in which the apparatus is used for cutting a pipe 1. In the illustrated embodiment, a machining unit 3 comprises a circular saw and the apparatus is designed as a hand tool in the example.

The apparatus comprises a gripping mechanism generally designated by reference numeral 2, which is adapted to be braced on the pipe 1 rotatably around the same. Rotation proceeds in such a way that the apparatus remains stationary in the axial direction of the pipe. Wheels 14, 15, 16 included in the gripping mechanism 2, the number of each being two in the illustrated exemplary embodiment, as shown in FIG. 1, are bearing mounted in such a way that, as the same are pressed against the external surface of the pipe 1, the gripping mechanism 2 can be rotated in a plane perpendicular to the centre axis of the pipe 1.

The gripping mechanism 2 is provided with a machining unit 3, constituted in the illustrated example by a circular saw which is pivotably attached by way of an axle 4 to the gripping mechanism 2 for moving the saw 3 relative to the gripping mechanism 2 towards or away from the pipe 1 (an arrow A, FIG. 2). Unlike FIG. 2, the axle 4 can be arranged also at the opposite end of the machining unit 3. The saw 3 has its blade 13 adapted to work from outside a rolling path common to the wheels 14, 15, 16.

The gripping mechanism 2 includes a frame section 5, and a first arm 6 and a second arm 7 extending therefrom. The gripping mechanism 2 is adapted to brace against the machinable body 1 by means of the wheels 14, 15, 16 or the like bracing elements mounted on the frame section 5 and the arms 6, 7. At one end, the arms 6, 7 are articulated to the frame section 5 of the gripping mechanism 2. The wheels 14, 15, 16 included in the arms 6, 7 are mounted on the free ends of the arms.

The gripping mechanism 2 has its frame section 5 rotatably and axially immovably provided with a threaded shaft 20. The threaded shaft 20 has its first end provided with a right hand thread carrying a first nut 21 and its second end with a left hand thread carrying a second nut 22. The threaded shaft 20 is fitted with an element 23, in the illustrated example with a turning knob, for rotating the threaded shaft 20.

For speeding up the opening and closing action implemented by means of the turning knob 23, the threaded shaft 20 may have one of its ends provided with a gearshift having individual transmissions for a quick action and the actual gripping.

The first arm 6 and the first nut 21 are articulated to each other by means of a first bracket 24. Respectively, the second arm 7 and the second nut 22 are articulated to each other by means of a second bracket 25.

Pivot axles 26, 27 between the arms 6, 7 and the gripping mechanism 2 are parallel to the axes of rotation for the wheels 14, 15, 16 mounted on the arms 6, 7 and the frame section 5. Each arm 6, 7, as well as the frame section 5, may be provided with one or more wheels 14, 15, 16. In the example shown in the drawing, the wheels 14, 15, 16 are set in pairs, as depicted in FIG. 1.

Unlike the illustrated examples, the frame section 5 may have its wheels (or bracing elements) 14 arranged on two parallel shafts, the bracing to a machinable body being implemented by means of wheels 14, 15, 16 mounted on four shafts or axles. Especially with small-diameter bodies 1, this facilitates installation of the apparatus.

In the illustrated example, the machining unit 3 is constituted by a circular saw, which is mounted on the pivotable gripping mechanism 2 about an axle 4 parallel to its axis of rotation 30 and to the centre axis of a machinable body 1 presently in a machining or handling position.

The inventive apparatus operates as follows.

The gripping mechanism 2, along with its saw 3, is fitted around the pipe 1 at a desired cutting point and the gripping mechanism 2 is secured in this position by means of the turning knob 23. If necessary, the pipe 1 to be cut can be secured in a suitable vice (not shown). Securing the pipe 1 is by no means always necessary. Rotation of the turning knob 23 causes the nut 21 in the right hand section of the threaded shaft 20 and the nut 22 in the left hand section to travel either towards or away from each other according to the direction of rotation. Through the intermediary of the brackets 24, 25 and the arms 6, 7, the motion is transmitted also to the wheels 15, 16, which respectively move either towards or away from each other. Thus, rotation of the turning knob 23 can be used for pressing the wheels 14, 15, 16 at a desired force against the external surface of the pipe 1.

When the gripping mechanism 2 is secured to the pipe 1, the saw 3 can be pivoted towards the pipe 1 about the axle 4 set in the frame section 5 of the gripping mechanism 2, the saw 3 having its blade penetrate through the wall of the pipe 1 to its per se known adjustable lower position shown in FIG. 2. This is followed by rotating the gripping mechanism 2, along with its saw 3, around the pipe 1 in the direction of an arrow B in FIG. 2 until the pipe 1 is severed.

1. An apparatus for machining, especially cutting tubular or round section bodies (1), said apparatus comprising a gripping mechanism (2), which is adapted to be braced on said machinable body (1) rotatably around the same and which gripping mechanism (2) is provided with a machining unit (3) fitted with adjusting means (4) for moving said machining unit (3) relative to the gripping mechanism (2) towards or away from the machinable body (1), and which gripping mechanism (2) includes a frame section (5) and first and second arms (6, 7) extending therefrom, the gripping mechanism (2) being adapted to brace against the machinable body (1) by means of bracing elements (14, 15, 16) mounted on the frame section (5) and the arms (6, 7), and which arms (6, 7) are at one end articulated to the frame section (5) of the gripping mechanism (2) and the bracing elements (15, 16) included in the arms (6, 7) are mounted on the free ends of the arms, characterized in that the machining unit (3) comprises a circular saw, which is pivotably mounted on the gripping mechanism (2) about an axle (4) parallel to its axis of rotation (30) and the centre axis of the machinable body (1) presently in a machining or handling position, that the frame section (5) of the gripping mechanism (2) is rotatably and axially immovably fitted with a threaded shaft (20), having at its first end a right hand thread with a first nut (21) and at its second end a left hand thread with a second nut (22), and said threaded shaft (20) being provided with an element (23) for rotating the threaded shaft (20), and
that the first arm (6) and the first nut (21) are articulated to each other by means of a first bracket (24) and the second arm (7) and the second nut (22) are articulated to each other by means of a second bracket (25).

2. An apparatus as set forth in claim 1, characterized in that the bracing element (14, 15, 16) comprises a wheel.

3. An apparatus as set forth in claim 2, characterized in that the arms (6, 7) and the gripping mechanism (2) are provided with intermediary pivot axles (26, 27), which are parallel to the axes of rotation for the wheels (14, 15, 16) mounted on the arms and the frame section (5).

4. An apparatus as set forth in claim 2, characterized in that each arm (6, 7) is provided with one or more wheels (15, 16).

5. An apparatus as set forth in claim 2, characterized in that the frame section (5) is provided with one or more wheels (14).

6. An apparatus as set forth in claim 1, characterized in that the frame section (5) is provided with two parallel axles for the bracing element (14).

7. An apparatus as set forth in any of claims 1-6, characterized in that the apparatus is designed as a hand tool.
